(19) United States
(12) Patent Application Publication
(10) Pub. No.: US 2008/0255873 A1
(43) Pub. Date: Oct. 16, 2008

(54) Method for Providing Health Care Services for a Group

(75) Inventor: Curtis Berkley, Knoxville, TN (US)

Correspondence Address: PITTS AND BRITTIAN P C, P O BOX 51295, KNOXVILLE, TN, 37950-1295, US

(73) Assignee: FamilyCare Specialists, Knoxville, TN (US)

(21) Appl. No.: 11/735,412

(22) Filed: Apr. 13, 2007

(51) Int. Cl. G06Q 50/00

(52) U.S. Cl. 705/2

(57) ABSTRACT

A method for providing centrally-managed health care services for a group. The method for centrally-managed health care services for a group provides a systematic approach to allow a group to implement a health care program tailored to meet the goals of the group and/or to be responsive to the health care needs of the participating members. Combining the objectives of the group, the medical histories of the participating members, the resources of the health care provider, a participation-based incentive program for participating members, and the availability of customized health screenings or health education, allows the medical services provider to offer a health care program to a group that balances the financial resources of the group with the available medical services to work towards a goal of improving the overall health of the group.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention relates to the provision of health care services. More specifically, this invention relates to a method for establishing and administering a health care program for a group.

2. Description of the Related Art

In recent years, the cost of providing health insurance has risen drastically. Moreover, the cost for obtaining health insurance as an individual is often prohibitive. Therefore, as insurance costs continue to escalate, the perception and necessity of effective group health care provision has changed from that of a standard benefit where the group, often an employer, pays for most or all of the health insurance premiums to an optional benefit with an increasing percentage of the premiums being passed on to the participating member.

As employers are beginning to see the end results of a workforce suffering from poor health, and as the cost in efficiency and financial resources that poor health is exacting on the workplace, more and more businesses are investing in comprehensive occupational medicine services to help prevent the development of poor health within the workplace. Simply, companies are beginning to realize that investing in preventative care and wellness often results in reduced health care costs and lost time due to employee sickness and injury. Monetary considerations aside, an effective health care program results in intangibles such as increased morale, increased employee satisfaction, and increased job performance, which are beneficial both to the employee and the employer.

While there are numerous health care strategies currently being used, none of the available health care programs address the need for organized health care that benefits both the group and its members. Typically, the health care program involves offering insurance benefits to a participating member at a premium secured by group. The health insurance premiums are directly related to the overall health of the group as determined by likelihood of certain events and the number of instances of catastrophic claims. Catastrophic claims are those that involve medical costs in excess of a certain dollar amount, for example, claims in excess of $100,000. The group may pay a portion of the premium but the health care program is treated as any other benefit such as a retirement fund or vacation time, i.e., participation by the participating member is completely optional. However, the health of the participating member has a direct bearing on attendance and job performance. Thus, it is in the best interest of the group to promote healthy practices for the participating members to improve quality of life for the participating members, improve productivity for the group, and to reduce health care costs for the group.

While the premiums for a group established by a health insurance provider are dependent on the overall health of the group as discussed above, any management by the health insurance provider is done on an individual basis and only occurs when a participating member takes the initiative to see a health care provider. Rather than being proactive, a health insurance provider is responsive and simply pays a claim when medical services are received by a participating member. Participating members who routinely ignore preventative care and, as a result, end up requiring later and more costly treatment are statistics that impact the entire group in the form of increased premiums. Further, health insurance providers are not at liberty to share medical information about participating members with the group. Thus, neither the health insurance provider nor the group has any real ability to make a difference in the overall health of the group.

### BRIEF SUMMARY OF THE INVENTION

A method for providing centrally-managed health care services for a group, or the health care program, is shown and described. The health care program provides a systematic approach to allow a group to implement a health care program tailored to meet the goals of the group and/or to be responsive to the health care needs of the participating members. Combining the objectives of the group, the medical histories of the participating members, the resources of the health care provider, a participation-based incentive program for participating members, and the availability of customized health screenings or health education, allows the medical services provider to offer a health care program to a group that balances the financial resources of the group with the available medical services to work towards a goal of improving the overall health of the group.

The health care program is generally provided through a managing entity or group having a number of members. Participating members sharing commonalities (physiological, gender, job description, etc.) may define a participating-member subset. Working with the group is a health care program coordinator. The health care program coordinator is the organizational unit responsible for developing, coordinating, and administering the health care program. Initially, the group and the participating members share information with a development unit which seeks to define the goals of the group and to compile information about the participating member.

Once the health care program is defined and implemented, the health care program coordinator coordinates the activities of the various organization units to administer the features of the health care program. Foremost, the health care program coordinator interfaces directly with the participating members, either individually or as part of the participating-member subset to which the covered individual belongs to provide routine health care services and/or education for which the group has contracted.

The health care program includes an inside health care provider which provides routine medical care and patient education. Where services exceeding the capabilities or contracted responsibility of the inside health care provider are involved, the health care program coordinator refers the covered individual to an outside health care provider for further treatment.

The health care program coordinator receives medical data or other information about the participating members from the inside health care provider or the participating member when an outside health care provider is involved. The information collected is that information which is useful or necessary to monitor the success or failure of the health care program overall, the overall health of the group, the overall health of a participating-member subset, and/or the health of a particular participating member and may extend beyond that which is normally considered routine medical data. The health care program coordinator ensures compliance with applicable state and federal laws, rules, and regulations and any other requirements or restrictions that apply to the health care program. For example, the health care program coordinator ensures that any necessary releases of information are obtained and compliance with any applicable privacy laws is maintained. The health care program coordinator provides the collected medical data to an analysis unit that provides such services as analyzing the collected medical data, identifying trends in the medical data, and reporting information, such as the overall health of the group and any changes therein, based on the medical data.

Another organization unit optionally involved in the health care program is the incentive provider. The incentive provider is the entity responsible for making an incentive disbursement to the participating member when the participating member complies with certain requirements of the health care program generally or a set of requirements specific to the participating member or the participating-member subset. The incentive provider receives the incentives from the group and authorization to release the incentive to the participating member from the health care program coordinator. Using incentives is one mechanism by which the health care program encourages the participating members to participate in educational events, attend follow-up medical visits, and other activities that are deemed to further the health care program goals. The incentives are generally targeted as rewards for participating in activities that are routinely ignored by individual participating members as being unnecessary, difficult, time-consuming, or otherwise burdensome with no immediate and direct consequence. As with the development unit, in some embodiments, the incentive provider is employed by or directly affiliated with the health care program coordinator. In other embodiment, the incentive provider is not directly connected to but responsive to direction from the health care program coordinator.

Together, the organization units described herein cooperate to form the participants in a health care program that is designed for and uniquely situated to address the specific health concerns of a group and its members to provide health care services within the financial resources allotted by the group and the goals of the group and/or the participating members. By having a coordinating entity that works with the group and the covered individuals to develop a custom health care program for the group and that works directly with the covered individuals to encourage participation and provide rewards for compliance with the health care program requirements, the health care program achieves success not available to programs lacking central management, such as a typical health insurance program.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates the organizational units used in the method of providing centrally-managed health care services for a group;

FIG. 2 provides an alternate view the organizational units used in the method of providing centrally-managed health care services for a group;

FIG. 3 broadly illustrates the method of providing centrally-managed health care services for a group;

FIG. 4 shows the development of the health care program in greater detail;

FIG. 5 shows the centralization of the health care program in greater detail;

FIG. 6 shows the provision of health care services in greater detail;

FIG. 7 shows the monitoring of participating members and analysis of health care program in greater detail;

FIG. 8 shows the reward/incentive program of health care program in greater detail;

FIGS. 9A, 9B, and 9C, collectively, illustrate a cross-function flowchart of the method of providing centrally-managed health care services for a group; and

FIGS. 10 illustrates a cross-function flowchart illustrating one embodiment of the incentive program of the present invention.

### DETAILED DESCRIPTION OF THE INVENTION

A method for providing centrally-managed health care services for a group, or the health care program, is shown and described. The health care program provides a systematic approach to allow a group to implement a health care program tailored to meet the goals of the group and/or to be responsive to the health care needs of the participating members. Combining the objectives of the group, the medical histories of the participating members, the resources of the health care provider, a participation-based incentive program for participating members, and the availability of customized health screenings or health education, allows the medical services provider to offer a health care program to a group that balances the financial resources of the group with the available medical services to work towards a goal of improving the overall health of the group and reducing health care costs through early diagnosis, preventative or maintenance treatment, patient cooperation, and/or education.

At the outset, it is noted that the ultimate goals of reducing health care costs and improving overall health are common to virtually all groups. The health care program described herein seeks to achieve these underlying goals and to address more specific goals of a particular group through cooperative health care that involves the group and the participating members. By encouraging participating members to take an active role in, restoring a sense of personal responsibility to good health practices, and removing impediments to healthy practices, the health care program described herein achieves the underlying goals within the bounds of the abilities of the group and the participating members.

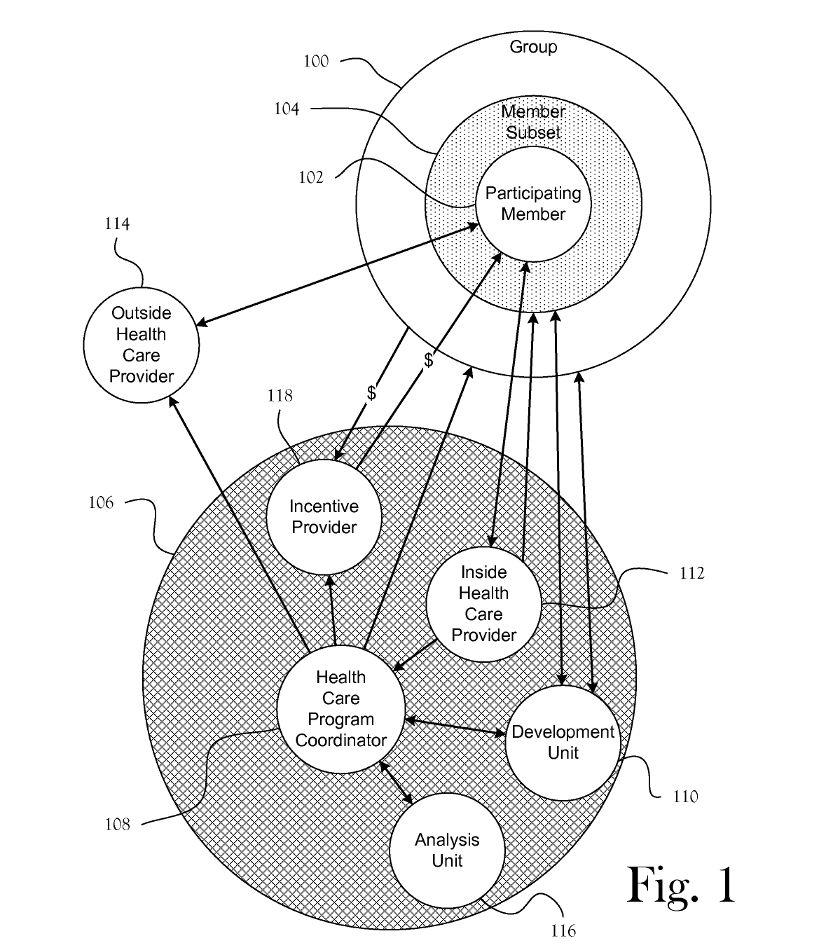

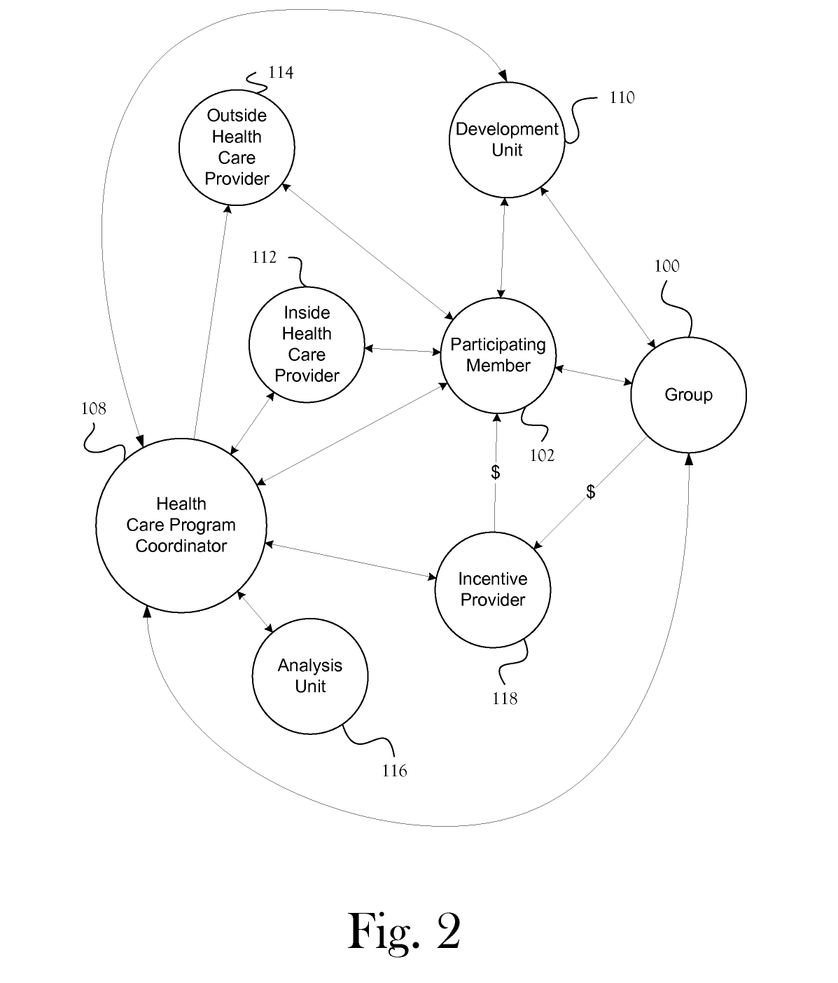

FIGS. 1 and 2 illustrate the organizational units that are involved in the health care program. In FIG. 1, the organizational units are grouped in larger managing entities. The health care program is generally a benefit available through a managing entity 100, which includes but is not limited to a group, organization, business, corporation, governmental entity, or a collection of one or more of these types of entities. For consistency, the term “group” shall be used to generically refer to the organizational unit offering health care benefits to its members. Each individual person that belongs to or is affiliated with any of the entities that make up the group and participates in the health care program is generically referred to as a covered individual or participating member 102. This broad definition of a participating member 102 is intended to include group members, immediate or extended family members of the group member, retirees of the group, and other individuals as appropriate. One skilled in the art will appreciate that participation by all group members is not a requirement for the success of the health care program, but as more group members participate the effectiveness of the health care program improves.

A collection of participating members that share a common feature is referred to as a covered class of individuals or participating-member subset 104. In one embodiment, the participating-member subset 104 is defined by occupation or by common requirements for or risks associated with a job description. In another embodiment, the participating-member subset 104 is grouped by commonalities in past or current medical conditions or physiological factors such as age, weight, or gender.

The managing entity managing the health care program is generally referred to the health care program provider 106. The health care program provider 106 provides or coordinates the health care program though an health care program coordinator unit 108, a development unit 110, an inside health care provider unit 112, an analysis unit 116, and an incentive provider unit 118. The health care program coordinator 108 provides coordination function for the development, provisioning, and administration of the health care program. Initially, the group 100 and the participating members 102 share information, often through a representative, with the development unit 110, which defines the goals of the group 100 and compiles information about the participating members 102. In one embodiment, the development unit 110 includes one or more individuals having medical training and/or experience in the health care industry to define the health care program within the bounds of medical standards. In another embodiment, the development unit 110 includes one or more individuals with program management experience and/or financial operations experience to help define the health care program within the bounds of the financial resources available to the group. In most cases, the development unit 110 is employed by or directly affiliated with the health care program coordinator 108; however, those skilled in the art will appreciate that the development unit 110 can be a separate entity that performs its functions and reports to the health care program coordinator 108.

The health care program coordinator 108 includes one or more medical professionals, along with other medical and administrative support staff, who coordinate with the development unit 110 to define the health care services that are to be provided to the various covered classes of individuals in order to meet the goals of the groups. Once the health care program is defined and implemented, the health care program coordinator 108 coordinates the activities of the various organization units to administer the features of the health care program. Foremost, the health care program coordinator 108 interfaces directly with the participating members 102, either individually or as part of the participating-member subset 200 to which the covered individual belongs to provide routine health care services and/or education for which the group has contracted.

The inside health care provider 112 which provides routine medical care and patient education. The inside health care provider 112 includes one or more health educators and/or licensed medical providers based on the services being provided. In a health care program providing routine medical care, examples of the services provided include annual check-ups, routine screenings, lab work, and patient monitoring/follow-up. In a health care program providing patient education, examples of the services provided include seminars directed to the group as a whole and/or one or more of the participating-member subsets, individual counseling, and other training. Where services exceeding the capabilities or contracted responsibility of the inside health care provider are involved, the health care program coordinator refers the covered individual to an outside health care provider 112 for further treatment.

The health care program coordinator 108 receives medical data or other information about the participating members 102 from the inside health care provider 112 or the participating member 102 when an outside health care provider 114 is involved. The information collected is that information which is useful or necessary to monitor the success or failure of the health care program overall, the overall health of the group, the overall health of a participating-member subset, and/or the health of a particular participating member and may extend beyond that which is normally considered routine medical data. The health care program coordinator ensures compliance with applicable state and federal laws, rules, and regulations and any other requirements or restrictions that apply to the health care program. For example, the health care program coordinator 108 ensures that any necessary releases of information are obtained and compliance with any applicable privacy laws is maintained. The health care program coordinator provides the collected medical data to the analysis unit 116 that provides such services as analyzing the collected medical data, identifying trends in the medical data, and reporting information, such as the overall health of the group and any changes therein, based on the medical data.

In one embodiment, the participating member 102 returns the medical information from the outside health care provider to inside health care provider 112 or the health care program coordinator 108. This allows the health care program coordinator 108 to pass the relevant medical information about the participating member 102 on to the analysis unit 116. In another embodiment, an outside health care provider 114 with appropriate releases supplies the medical data about the participating member 102 directly to the inside health care provider 112 or the health care program coordinator 108. Having all relevant medical information pass through the heath care program coordinator 108 allows the health care program coordinator 108 to maintain a coordinating role and control the flow of information and to better manage and administer the health care program.

Another organization unit involved in the health care program is the incentive provider 118. The incentive provider 118 is the entity responsible for making an incentive disbursement to the participating member 102 when the participating member 102 complies with certain requirements of the health care program generally or a set of requirements specific to the participating member 102 or the participating-member subset 200. The incentive provider 118 receives the incentives from the group 100 and authorization to release the incentive to the participating member 102 from the health care program coordinator 108. Using incentives is one mechanism by which the health care program encourages the participating members 102 to participate in educational events, attend follow-up medical visits, and other activities that are deemed to further the health care program goals. The incentives are generally targeted as rewards for participating in activities that are routinely ignored by individual participating members 102 as being unnecessary, difficult, time-consuming, or otherwise burdensome with no immediate and direct consequence. As with the development unit 110, in some embodiments, the incentive provider 118 is employed by or directly affiliated with the health care program coordinator 108. In other embodiment, the incentive provider 118 is not directly connected to but responsive to direction from the health care program coordinator 108.

FIG. 2 illustrates the organizational units of the health care program without the larger managing entities. In the illustrated embodiment, the each of the organization units including the coordinator unit 108, the development unit 110, the inside health care provider unit 112, the analysis unit 116, the incentive provider 118, the outside health care provider 114, the group 100, and the participating member unit 102 are shown as independent organization units. However, each independent organization unit has interaction with the coordinator unit 108 allowing the health care program to function as intended regardless of the actual relationship between the individual organizational units. Thus, combining organization units or varying the relationship of an organizational unit with one of the managing entities is not considered a departure from the scope and spirit of the present invention. In an example of one such embodiment, the incentive provider 118 is part of the group 100 but its operation within the health care program of the present invention is at the direction of the health care program coordinator 108. One skilled in the art will recognize that the health care program and the organization units therein can vary based on the needs and/or desires of the group and the participating members without departing from the scope and spirit of the present invention. Thus, an organizational unit may be omitted from the health care program where its functions are not required.

Together, the organization units described herein cooperate to form the participants in a health care program that is designed for and uniquely situated to address the specific health concerns of a group 100 and its members 102 to provide health care services within the financial resources allotted by the group 100 and the goals of the group 100 and/or the participating members 102. By having a coordinating entity 200 that works with the group and the covered individuals to develop a custom health care program for the group and works directly with the covered individuals to encourage participation and provide rewards for compliance with the health care program requirements, the health care program achieves success not available to programs lacking central management, such as a typical health insurance program. Further, it will be recognized by one skilled in the art that the health care program operates either in conjunction with or in lieu of traditional health insurance services and outside medical providers without departing from the scope and spirit of the present invention.

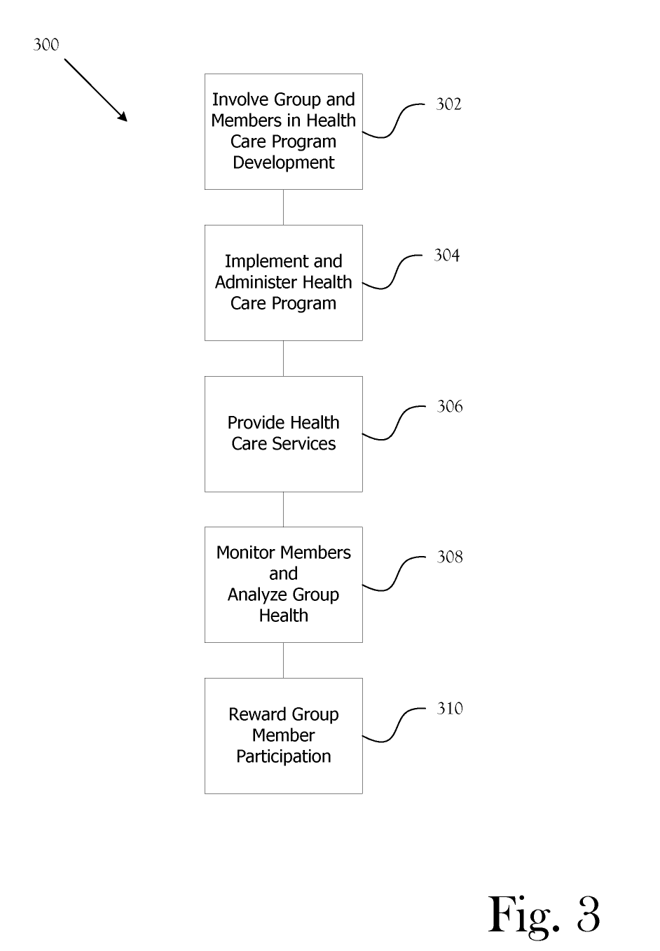

FIG. 3 shows the general method of providing centrally-managed health care services to a group 300. The initial step is the development 302 of a health care program using active participation from the group and the participating members. This approach is not utilized with conventional group health care programs, which generally offer a selection of one or more individual health insurance policies at group rates. Next, implementation and administration of the health care program that was developed is established 304 to facilitate centralized provision of services, monitoring of performance, encouraging participation, and evaluating program results. Again, central management is not utilized with conventional group health care programs, which generally provide benefits on an individual basis, require initiative on the part of the individual to address health concerns, and independent health care providers do not share information. Subsequently, health care services and training are provided 306 through a designated health care provider associated with the health care program. The health care program coordinator oversees 308 the health care program by collecting participating member data, monitoring participating member progress, and confirming participation in the health care program by individual participating members seeking incentives. Over time, the health care program coordinator compiles and aggregates data that is analyzed to identify changes in the overall health of the group and/or the achievement of specific goals of the health care program as defined by the group. The results of the analysis are conveyed to the group in the form of reports, charts, graphs, or other appropriate forms of communication. When a participating member meets incentive requirements, the health care program coordinator authorizes 310 a reward, which is issued to the participating member by the incentive provider.

One skilled in the art will appreciate that many treatments and lifestyle changes associated with improving health take time to implement and show results for individuals. Further, sufficient time must be allotted when monitoring the overall health of a group before improvements of statistical significance will become apparent. While the timeframes will vary with the specific goals and health care program that is implemented, the present inventors have found that a period of three years from the inception of a general health care program for a municipality was necessary to obtain sufficient meaningful data to establish the success of the health care program.

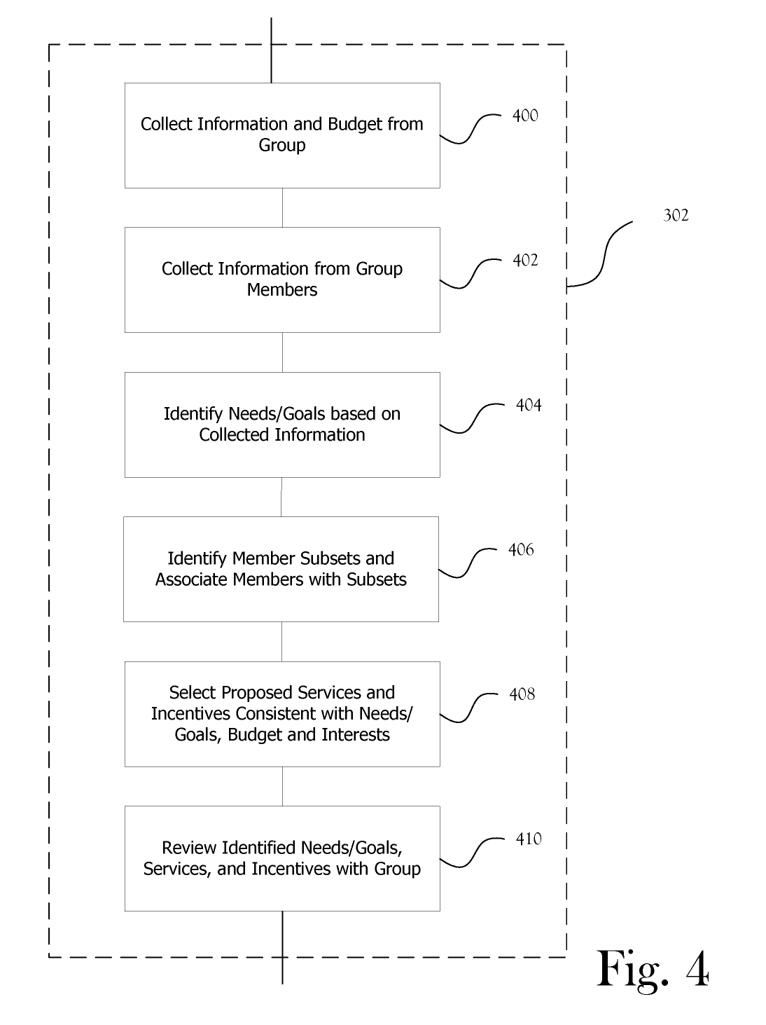

FIG. 4 provides greater detail into the activities involved in the development of the health care program responsive to and in cooperation with the group and the participating members. The activities involved herein are in contrast with the approach used in conventional group health insurance programs where the group is presented with options for different health care insurance plans. The differences between the health insurance plans amount to variations in benefit levels, premiums, and out-of-pocket cost to the individual subscriber. An inquiry into the overall health of the group is limited to consideration of the number and payout of claims within the group for setting the premiums for the group. Thus, the group has little real input into the coverage available and virtually no control over the number or severity of claims, especially catastrophic claims, which influence the cost of the health insurance plan, because it is impracticable for the group to exercise control over the health care choices of the participating members.

In implementing an effective group health care program, problems occur both in identifying the appropriate health care services necessary for achieving the desired results, and in encouraging individual employees to adhere to the established health care routines. Simply treating a symptomatic recurring health problem amongst participating members traced to a specific cause, such as common exposure to a toxin or pathogen, is necessary but is a short-term solution that is ultimately ineffective in actually improving overall health of the group. Long-term solutions involve identification and removal of the source and education (e.g., the dangers of and safety precautions when dealing with lead-based paint or testing for and avoiding contaminated drinking water). Thus, the cooperative development effort is designed to collect sufficient information to develop a workable health care program that is acceptable to the group, will be used by participating members, and seeks to promote selected health care goals. Further, the data collection process is well-suited to be performed as an iterative process, including both the group and the group members as necessary, allowing for refinement of health care program and or obtaining more specific information needed to complete the development of the health care program.

Initially, the development unit obtains 400 information from the group, typically from the management of the group. Examples of the information obtained from the group include the budget allotted for the health care program, identification of participating-member subsets based on job description or occupation, specific job performance requirements for or industry standards applicable to any participating-member subset, any medical concerns identified by the group, any job performance concerns identified by the group, factors such as lost time due to sickness and injury, past and present health insurance information (rates, participation, etc.), the primary services expected such as annual health screenings for the municipality employees, and the incentives, if any, that will be provided to encourage member participation, desired results, and definitions of program success. This information is obtained through interviews of group management, site surveys, ecological testing, and published medical standards. Depending upon the size of the organization and the desired information being collected, surveys may also be used to obtain information from lower level managers and supervisors.

In cooperation with the group, the development unit performs a financial assessment to determine any financial constraints associated with the group funding the health care program. Those skilled in the art will recognize various factors pertinent to a financial assessment determining such financial constraints, including but not limited to the ability and willingness of the group to provide funding, and the particular scale and scope of the health care program desired by the group. In one embodiment, sufficient information is obtained from the group to establish a health care program for presentation to the group members without the need for input from the group members.

Next, the development unit communicates with and obtains 402 information from the group members including information such as medical histories, specific medical concerns, requested services, employee satisfaction evaluations, identification of impediments to participation, likelihood/willingness to participate, preferred/motivating incentives, desired results, and definitions of personal success. Generally, the major features of the health care program are set by the group and the group members input result in minor modifications to the implementation or providing direction as to the prevalent health conditions, however, a group may elect to have greater input from the members in the development of the health care program. The development unit considers whether the input from the group members is consistent with and can be incorporated into the health care program envisioned by the group. Selected suggestions or findings from the group member input that are compatible with the budget, expectations, and/or goals of the group are presented to the group for inclusion into the health care program. Where group member findings or suggestions are incompatible with the budget, expectations, and/or goals of group but are considered relevant or necessary to the successful implementation of the health care program, such findings or suggestions are also presented to the group.

Initially, the collection of information generally involves all members of the group, without regard to participation and includes more general and less personal information is collected. Including all group members better represents the interests of all members but may limit the amount of personal information which may be requested. Once a preliminary health care program has been established, group members may be given the opportunity for early enrollment. Those members opting for early enrollment are generally more likely to provide meaningful responses and provide more personal information at the expense of the broader interests of the group members as a whole. Other models for obtaining the desired information include surveying group members as a whole but asking for more personal information, clearly indicating that responses to requests for personal information are optional, and offering incentives for providing the requested information.

Information about group members is primarily collected through surveys and/or interviews. Where the number of group members is large, interviews may be omitted or reduced by limited interviews, for example interviewing a random sample of participating members or selected participating members based on survey responses. Those skilled in the art will appreciate the various methods of collecting information and recognize the inherent advantages and disadvantages of each method. In one embodiment, data collection involves gathering past medical records and the like, for each participating member. Information obtained from medical records is likely to be more reliable but the difficulty in obtaining such records limits the effectiveness of this method. Further, past medical records will not identify current but previously unaddressed medical conditions.

Once the information from both the group and the participating/group members has been compiled, the development unit evaluates the goals defined by the group in light of the information about the overall group health, the expectations of the members, and the expertise of the development unit. The result of this evaluation is the identification 404 of recommended goals for the health care program either through the confirmation of the stated goals of the group or modified or alternative goals that better address the actual concerns of the group and the participating members. By way of example, the group and/or the members may identify obesity as a health concern and combating obesity as a goal. If the medical information confirms that a significant number of the participating members are classified as obese, a conclusion that health care program should address the issue of obesity is consistent with both the stated goals and the apparent goals obtained by the collection and evaluation of the information. In contrast, where controlling high blood pressure is the stated goal but the medical histories indicate a significant number of the participating members have depression while the prevalence of high blood pressure is low; the development unit will recommend that mental health services be included as part of the health care program and blood pressure monitor be handled as part of the regular screenings.

As previously stated, it is presumed that the goals of any group are generally related to the reduction of health care costs and/or the improvement of the overall health of the group members. Where the group does not express a specific concern or goal or the expressed concern or goal is controlling health care costs or improving overall health, the development unit identifies goals that address health conditions that are prevalent, serious, and/or result in higher health care costs (i.e., large numbers or expensive claims). To this end, one embodiment of the health care program establishes a goal to specifically reduce the severity of at least one health concern. For example, where high blood pressure is identified as a concern, the identified goal might be to reduce the average blood pressure of the participating members or to reduce the number of participating members exhibiting high blood pressure by a specified percentage. However, one skilled in the art will appreciate that the goal established need not specifically reduce the severity of the at least one health concern. For example, in one application of the method in which a health concern of osteoporosis is identified among a significant percentage of the patient set, a goal is established to increase the overall education of the patient set in regards to the nutritional needs of the individual patients. Those skilled in the art will appreciate that numerous variations in the established goal are possible, depending upon the specific needs or expectations of the participating members, as well as the needs or expectations of the group.

In one embodiment, the evaluation is made solely from the data associated with the group and the results are used to define the concerns for the group. The initial evaluation of the overall health of the group also serves as a basis for later comparisons of the success of the health care program. In another embodiment, the collected data includes both medical and bibliographic/statistical/census information (age, sex, race, weight, etc.) for each participating member. The information associated with the group is compared against the same data from general population samples to determine the relative health of the group. This type of analysis provides useful insight where a group evidences higher and statistically significant instances of conditions such as cancer and allows the development unit to investigate whether some environmental condition common to the group is responsible. Even where no health anomalies are identified, the general population data services as a baseline for evaluating the success of the health care program. The general population samples are available from governmental entities or other interested entities, such as insurance companies.

As part of the development of the health care program, the data is compiled and analyzed to identify 406 any participating-member subsets having conditions that should be addressed and assigns those participating members to appropriate participating-member subsets based on interests and conditions. Examples of interest-based participating-member subsets include an exercise subset and members desiring to stop smoking. Condition-based participating-member subset examples include chronic disease management. One skilled in the art will appreciate that the subsets can be further refined as necessary to reflect management of specific diseases or the development of exercise programs based on relative health.

The development unit further determines, based on the analysis of collected information, various parameters of the medical services included in the health care program. Once the evaluation of the information and the identification of real and perceived goals are completed, the development unit selects 408 a proposed set of health care services that are consistent with those goals and can be accomplished within the budget set by the group. The development unit considers factors such as the existing heath conditions of the participating members, the allotted funding, the number of participating members, the available staffing and resources for providing health care services, the established time frame, and acceptable medical practices to define the services designed to achieve the desired goal and how the services can be administered in manner that meets the expectations of the group and the participating members. In addition to standard medical care, ancillary services such as mental health care, counseling, dental care, drug testing, vision and hearing testing and/or care, and other such services are considered for inclusion in the health care program. One skilled in the art will appreciate numerous other parameters that influence the selection of the health care services that may be used without departing from the spirit and scope of the present invention.

In one embodiment, the development unit determines the frequency of health care services provided to the participating members in order to achieve the goal. In another embodiment, the development unit determines the method in which the health care services are applied. In still another embodiment, the development unit determines what health care services are applicable to specific participating members. In some embodiments, the selected health care services are applicable to all participating members. This is especially common where the goals set by the group are primarily centered on general health concerns or health education. An education-focused group may define success as holding a specified number of health education seminars within a specified time frame and provide incentives based on participating member attendance at a selected number of the seminars. A general health-focused group might define success as providing no-cost annual physicals screening for general health concerns to all participating members. The global health care services may even be directed to a specific health concern where a group defines success as reducing the number of occurrences of a condition (e.g., strokes) in the group by a selected number. The services provided to all participating members would encompass monitoring, diagnosis, and treatment of strokes regardless of the risk of stroke for any individual participating member.

In other embodiments, the health care services vary for differing participating-member subsets. Such situations arise where the development unit identifies a specific demographic or member subset to which certain health care services are provided. For example, the participating members presenting abnormally high blood pressure are designated to receive more frequent blood pressure testing than the participating members presenting normal or abnormally low blood pressure. Another example would be a group having a diverse collection of members, which include uniformed employees (e.g., police or fire fighters), professional/administrative/clerical staff, and laborers, each of which might be considered a participating-member subset. The physically active participating-member subsets (i.e., police, fire fighters, and laborers) are likely to experience vastly different health concerns from the more sedentary participating-member subset (i.e., professional/administrative/clerical staff. Further, published fitness standards for particular participating-member subsets (e.g., police and fire fighters) may designate more rigorous health standards for such employees. While the overall health care program may establish an annual physical, the thoroughness of the physical, and the specific conditions being checked during the physicals can be varied for the different participating-member subsets. In addition, participating-member subsets having dangerous or high stress jobs may be provided with counseling services not available to participating-member subsets encompassing low-stress jobs. Where the participating-member subsets are defined by medical condition rather than occupation, the services may include specialized support mechanisms for each participating-member subset. Such support mechanisms include breakout sessions addressing issues such as diabetes, high blood pressure, smoking, or addiction.

The present inventors have found that the expectations of the employees are likely to differ from those of the employer. One specific example pertains to the timing of the health care services where participating members were generally more accepting of the annual health screenings when the screenings were performed on-the-clock while the group expressed an interest in avoiding interruptions of the normal business functions during the hours of operation of the group. Employees were less inclined to participate when the screenings were to be handled on their own time, even when the screens were provided at little or no cost. The development unit considers the data collected to develop health care program that will meet the expectations of those involved. Using the specific example of the timing of the screenings, the development unit compares the economic and productivity cost to the municipality of providing the screenings during working hours to the economic and productivity cost to the municipality of restricting the screenings to be done on the employees own time. In addition to the calculations, the development unit produces options for consideration by the municipality such as making off-the-clock screenings free, rewarding employees for having a screening done off-the-clock, making on-the-clock screenings a condition of employment, or allowing on-the-clock screenings at a small monetary cost to the employee. Each of these approaches attempts to balance the expectations of the employer and the employee while still achieving the ultimate goals of reducing health care costs and improving employee health but will have different levels of acceptance, participation, and effect on morale. While not a health concern, such expectations have a significant impact on the development and success of the health care program.

Upon completion of the evaluation by the development unit, the proposed health care services and the underlying rationale are reviewed 410 with the group. The group has the opportunity to express any concerns or suggest changes to the proposed health care program. If changes are deemed necessary, the development unit adjusts the health care program to match the expectations of the group. Following the earlier example, after considering the economic and productivity studies and the options from the development, the group elects to provide annual screenings on-the-clock at no cost to participating members using a medical practitioner who travels to the participating member to minimize workplace disruption. Once the health care services are approved by the group, the health care program is implemented.

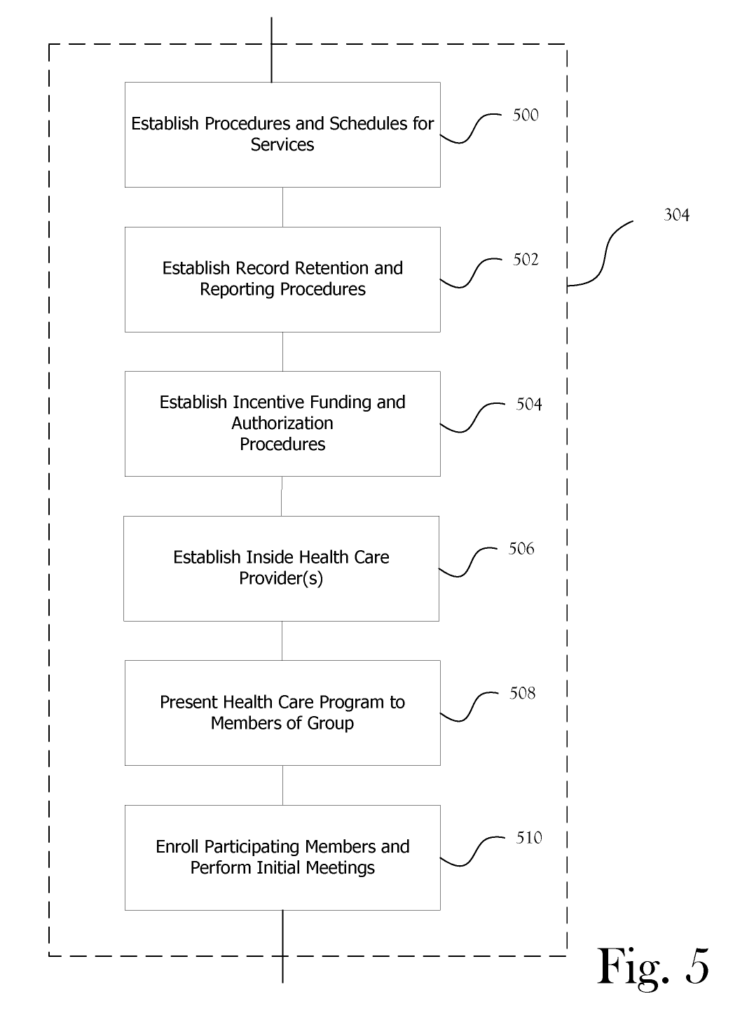

FIG. 5 explores the implementation and administration of the health care program in greater detail. Generally, the implementation and administration process involves establishing the procedures by which the health care program operates in an organized and centralized manner. This involves defining 500 procedures for scheduling health care services such as screenings and training with participating members. Organization and centralization also involves setting up the documentation, record retention, and reporting 502 procedures to ensure that information is communicated between the various units of the health care program. For example, procedures are necessary for ensuring medical records about the participating members are kept in a consistent fashion to allow the medical data to be analyzed for changes and to ensure compliance by the participating member with health care program requirements that qualify the participating member for incentives. It is also necessary to limit the flow of private medical information to comply with privacy laws and further limit the information reported to only that which is required for the function. Using authorization of an incentive as an example, the incentive provider only needs to know the participating member and the incentive for which the participating member qualified but not any information about the condition of the participating member of what the participating member actually did to qualify for the incentive. Establishing reporting procedures optionally involves generation of forms to be completed by outside health care providers to ensure the participating member returns accurate and necessary information, if required.

Next, the mechanisms which ensure that the incentive program is properly funded, that the incentive program is free from abuse, and that the incentives are provided on timely basis are established 504. The incentive program procedures define to whom, when, and how funding requests are made by the incentive provider. The procedures also define how and when incentives are distributed to qualifying participating members. Finally, the procedures define who authorizes an incentive distribution to a participating member and the form of such authorization.

The administration process also involves establishing 506 a centralized network of inside health care providers. Where a single inside health care provider is used, centralization is inherent. However, for larger groups, centralization involves the identification of approved health care providers who participate in the health care program and are designated inside health care providers. This should not be confused with participating physicians on health insurance plans. The inside health care providers are directly and actively involved in the health care program, provide services in accordance with the standards of the health care program, and report directly to the health care program.

Another significant aspect of the implementation and administration functions is the presentation 508 of the plan to group members. The terms and conditions of the health care program are provided to the group members. Presentation of the health care program is accomplished primarily through the distribution of written materials and optionally may include meetings directed to all group members and general policies are explained to provide group members with sufficient information to determine whether they wish to enroll.

Group members are presented an opportunity to enroll 510 as participating members. In another embodiment, participation is required by all group members and the need for actual enrollment is obviated. In yet another embodiment, where early enrollment was available, participating members have the option of withdrawing from participation. The enrollment forms collect any additional information required, including specific medical information. Once the enrollment period closes, one or more initial meetings are held by the inside health care provider in which the health care program is explained. The initial meeting is for participating members as a group, a member subset, or an individual participating member and specific program requirements are explained.

The initial meeting with participating members further serves as an event through which further health care is scheduled. In one embodiment, an initial health screening is performed to confirm and supplement the medical information provided by the participating member. In one embodiment, at the initial meeting the inside health care provider gives the participating member a schedule of appointments specifying the times and locations at which further health care services are to be provided to the participating member. In another embodiment, the inside health care provider gives a participating member a schedule of educational seminars or member subset events available to or applicable to the participating member. The educational seminars cover various methods and practices to improve personal health are conducted by the inside health care provider. Member subset events provide motivation, support, training, and specific information pertinent to the participating member for such issues as chronic disease management, grief support, and addiction recovery. In another embodiment, the initial health care provider gives the participating member a personal health plan. The personal health plan provides a list of activities or targets that the participant members should strive to achieve. More detailed personal health plans include time lines for achievement. In one embodiment of the health care program, the personal health plan sets forth requirements to qualify for certain incentives. In addition to personal health plans, participating members in subsets such as chronic disease management or weight management are instructed how to maintain a log of events, test results, or other relevant information to track changes and encourage participation. The log is generally provided to the inside health care provider on a designated schedule, and, where incentives are used, the log is required to qualify for specific incentives.

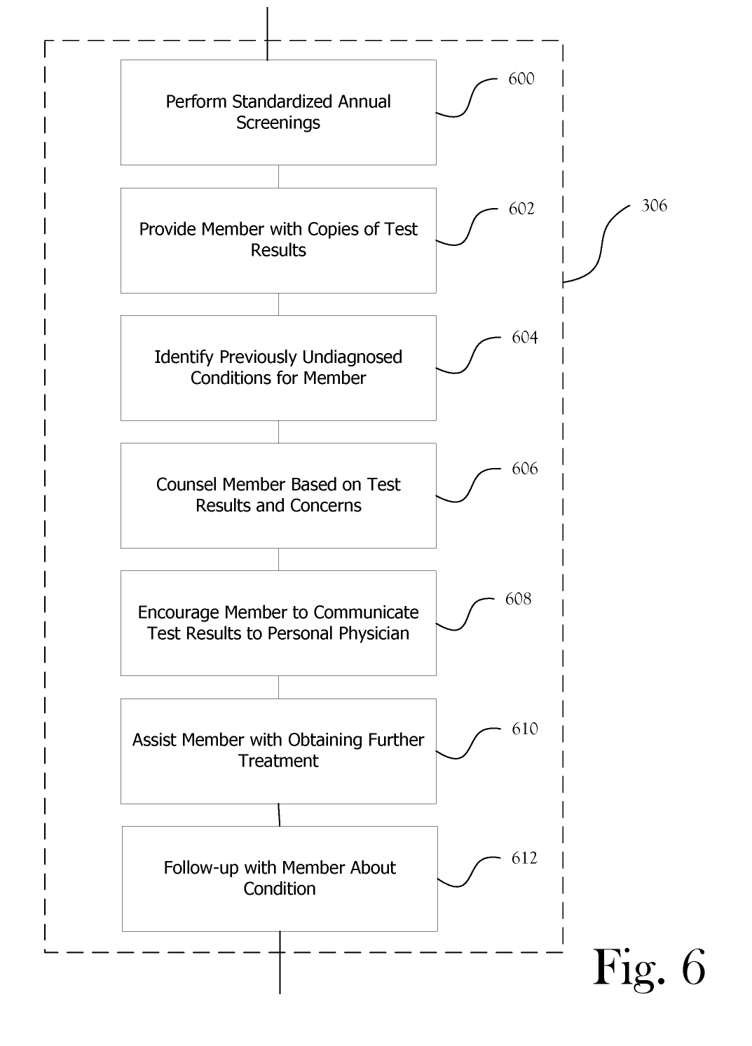

FIG. 6 shows the provision of the annual screenings within the health care program in greater detail. Initially, the inside health care provider provides 600 standardized annual screenings for participating members. In one embodiment, the standardized annual screenings follow universally recommended health screening procedures. The present inventors have found that, consistent with broader studies, a majority of adults do not receive the universally recommend health screenings from their regular physicians. The health care program enjoys the benefit of centralized administration and services therefore the annual screenings provide participating members with consistent and comprehensive services. Further, the health care program has a direct relationship with the group and has a vested interest in improving the overall health of the group and reducing health care costs. Thus, the inside health care provider actively seeks early detection and diagnosis of conditions that have potential to develop into dangerous or expensive conditions if left untreated. Through annual standardized screenings emphasizing comprehensive testing, early detection and treatment, the health care program reduces the number of participating members who do not seek medical attention until an untreated condition has developed serious complications.

To facilitate the aforementioned goals, the inside health care provider provides 602 the participating member with a copy of all test results from the screening. Any previously undiagnosed conditions are identified 604. The inside health care provider counsels 606 the participating member about the test results, going over changes in previously diagnosed conditions, explaining the previously undiagnosed conditions, and addressing any additional concerns expressed by the participating member. This also includes services such as setting up an action plan for the participating member that establishes health-related milestones for the participating member. An action plan provides the participating member with responsibility for their own health, accountability to the inside health care provider, and a measure that can be used in an incentive-based health care program. The inside health care provider further encourages 608 the participating member to communicate the test results and any concerns to their personal physician.

The use of outside health care providers, including personal physicians, specialists, and hospitals, is used to fully implement the health care program. Providing comprehensive treatment for all medical conditions is generally outside the scope of responsibility of the health care program, although some embodiments of the health care program include additional treatment services. It will be appreciated that the primary focus of the inside health care provider is to provide comprehensive, standardized testing that is readily available to participating members and which enables participating members to learn about and address conditions before serious complications develop. To this end, the inside health care provider also assists 610 the participating member with scheduling follow-up treatment. This includes recommending qualified physicians, providing referrals, and scheduling of appointments for the participating member.

Finally, the services provided by the inside health care provider also includes follow-up 612 with the participating member. In the simplest form, follow-up involves the inside health care provider receiving information from the participating member about treatment by the outside health care professional. In another embodiment, follow-up services involve reviewing logbooks kept by the participating member or periodic check-ups for specific conditions. A periodic check-up is generally less comprehensive than an annual screening. By providing the participating member with a readily accessible resource where concerns can be addressed and successes celebrated, many of the interpersonal impediments to seeking medical care are removed.

In one embodiment, the health care program customized multi-level screenings in order to manage costs while maintaining effective monitoring of participating member health. A multi-level screening system includes a plurality of different screening procedures based on selected criteria. The most rigorous screening level encompasses the most comprehensive set of tests and lab work given to a participating member, referred to as a full screening. A lower level of screening removes some tests and lab work that apply to conditions with low occurrence rates or low risk of serious complications, referred to as an interim screening. Each level of screening has application criteria associated with it to ensure that all participating members receive a full screening on an appropriate schedule.

One embodiment of the multi-level screening schedules the frequency of the full screening on a periodic basis with interim screenings occurring between full screenings. The frequency of the full screening is based on one or more criteria developed as part of the health care program. The criteria involved in the scheduling of full screenings include the participating member's age, race, gender, and other risk factors associated with conditions being tested. In another embodiment, the frequency of full screenings is varied on an individual basis for a participating member having a special condition warranting a departure from the general schedule. An example of one embodiment of the health care program uses age as the criteria setting the frequency of full screenings. For those participating members under the age of forty, a full screening is performed every two years. Participating members reaching the age of forty receive full screenings annually. This allows resources to be conserved by limiting routine testing for age related conditions to those participating members most likely to exhibit those conditions. Using age-based scheduling, prostate exams and pap smears are generally unnecessary as the associated conditions are rarely found in persons under the age of forty. Full screening frequency schedules provide guidelines on which to base the comprehensiveness of routine annual screenings, but a more comprehensive screening is always available regardless of schedule when an indicator suggesting that additional testing is warranted exists.

In another embodiment, the annual screenings are also designed to be balanced between various participating-member subsets. For example, considering gender differences it is not equitable to provide prostate exams and test for prostate-specific antigens in men without providing equivalent testing (pap smears, pelvic exams, or testing for human papillomavirus) in women. One skilled in the art will recognize that some testing is specific to a single participating-member subset without corresponding conditions in other participating-member subsets, such as specific conditions that afflict only persons of a particular race. In one embodiment, where the unique condition is of significance, the full screening includes tests that are directed to that condition but are only given to appropriate participating members.

Finally, as previously mentioned, the screening procedures in one embodiment of the health care program vary based on factors such as job requirements or other obligations. Civil service employees, such as police and fire fighters, are required to maintain certain fitness standards as a condition of employment. Further, the ability for a policeman or fire fighter to physically perform job duties may warrant different screening procedures than those for laborers, clerical, and professional staff. Thus, another embodiment of the multi-level screening service would offer full screening to all participating members on an equivalent basis but the definition of a full screening varies between the participating-member subsets based on job type, referred to as an occupation-specific screening. In yet another embodiment, the multi-level screening services depend on two or more independent criteria, for example, occupation-specific screenings including both full screenings and interim screenings are used to extend limited resources.

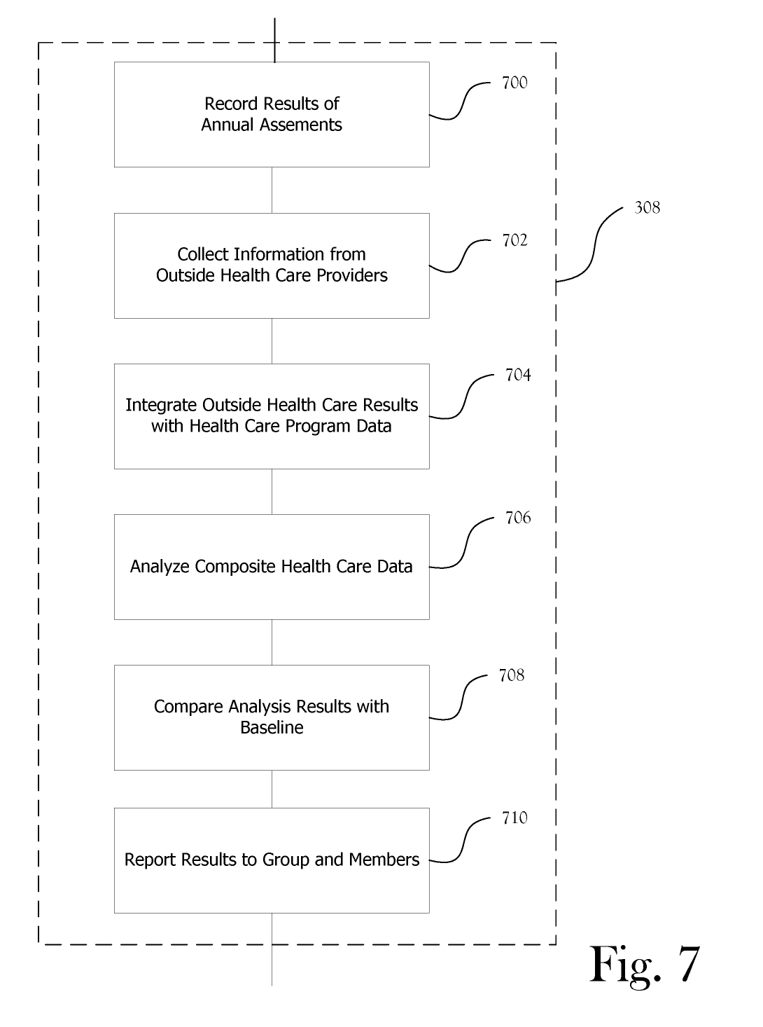

FIG. 7 illustrates the monitoring and collecting of participating member progress in greater detail. Initially, the records for participating members obtained during annual assessments are complied and maintained 700. Even without additional information from outside sources, the records of the annual assessments include sufficient data to track changes in the severity and prevalence of conditions being monitored.

Given that the health care services generally provided by the health care program provider are limited to assessment, education, support, and referral rather than treatment, in most cases, more comprehensive analysis is possible by obtaining 702 information about participating members from outside health care providers. Due to privacy concerns and legal restrictions, the participating member generally serves as intermediary by obtaining information from the outside health care provider and then returning that information to the health care program provider. In one embodiment, the health care program provider obtains a release from the participating member to request information from outside health care providers and subsequently contacts the outside health care provider directly. Alternatively, the health care program provider optionally provides participating members with a form to be provided to an outside health care provider at the time of service, which includes language necessary for the release of personal medical information by the outside health care provider and directs the outside health care provider to return a copy of the results to the health care program provider.

It should be appreciated that the health care program provider will only be able to obtain information about a participating member from an outside health care provider when it has notice that outside health services have been used. Thus, the incentives and coordination of outside services are useful tools to aid in collecting information from outside health care providers. In another embodiment, one or more outside health care providers are affiliated with the health care program and agree to flag the records of participating members who authorize the outside health care provider to provide information to the health care program provider. In such an arrangement, the health care program provider will receive information about the participating member without placing a burden on the participating member to notify the health care program provider when outside services are used.

In many cases, the type and amount of information received from the outside health care provider requires the health care provider to assess and integrate 704 the outside data into the health care records being maintained by the health care provider to allow for later analysis. As previously mentioned, the health care program provider optionally provides participating members with a form to be completed by an outside health care provider to allow standardized information to be obtained in order to simply record integration.

The health care records are then analyzed 706 using statistical analysis tools, software, and other methods to monitor the use of health care services, the effectiveness of incentives, participation by members, the prevalence of a selected condition, the severity of a selected condition, changes to indicators associated with a selected condition, and other relevant data about the health and activities of the participating members. Further, the analysis also allows the health care program provider to identify trends, obtain counts, flag anomalies, highlight areas of concern, and other similar results which may be used to evaluate the health care program. The analysis also generally considers indicators relating to the general objectives of reducing health care costs and improving overall group health and the general or specific objectives of the group. The data being analyzed is general aggregate data having little risk of disclosure involving privacy concerns.

The analysis results are compared 708 against the baseline and/or previous analysis results to establish the effectiveness of the health care program in meeting the general and specific objectives of the group and the general and specific objectives of the health care program over time. The results and the comparisons, once again in an aggregate form, are compiled into a report provided 710 to the group and, optionally, to the group members. The report provides the group with an opportunity to consider the effectiveness of the health care program and documentation that may be used when negotiating health insurance premium prices or to contest health insurance premium increases. The report also validates the heath care objectives of the group and/or the group interest in promoting improvement in the overall health of the group. In the case of a group where the recommendations of the development unit were ignored with respect to viable opportunities for addressing group health issues or the health care objectives were too general or vague to have significant impact on the overall health of the group, the report serves as a catalyst to reconsider and modify the health care program to better address the health care needs of the group.

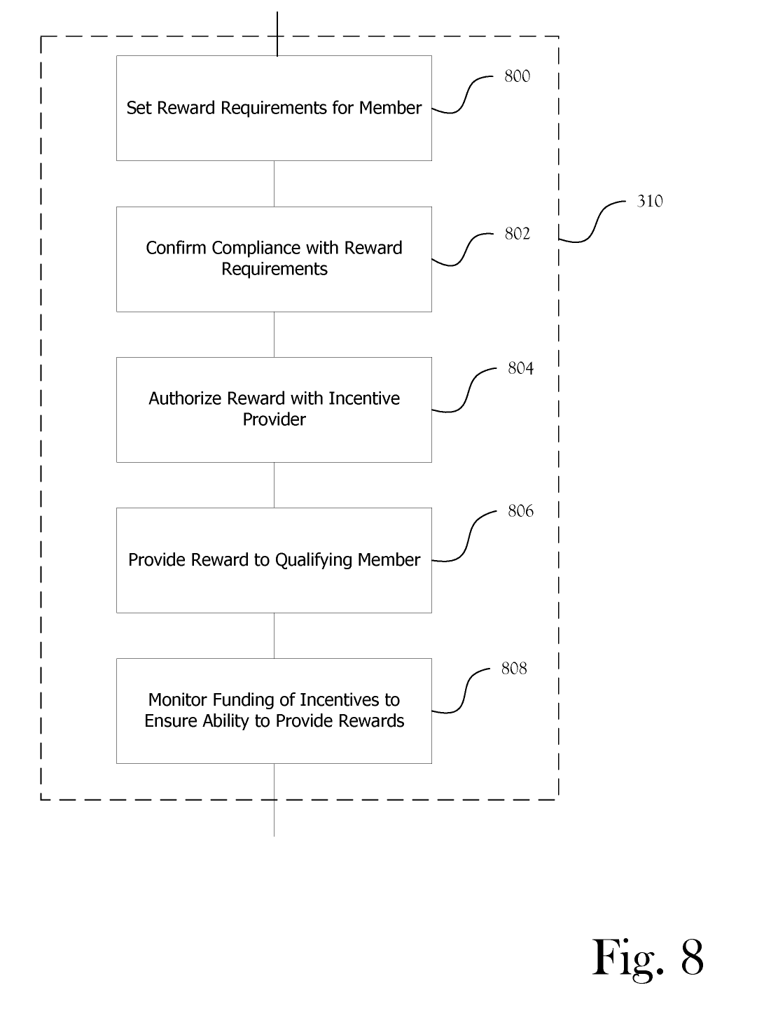

FIG. 8 illustrates the authorization and distribution of rewards or incentives in greater detail. Although optional, the incentive program is a useful tool for overcoming impediments to participation in the health care program. Such incentives are not available in conventional health care plans or are not directed towards the group health objectives. A typical insurance plan requires co-payments for each medical visit. An individual experiencing an actual medical problem accepts the co-payment as necessary for receiving medical treatment. However, an individual often elects to skip well-visits, preventative care, and routine follow-up visits to avoid the unnecessary expense of the co-payment when nothing is wrong. By skipping preventative care, early warning signs of a condition may be missed and such conditions are left untreated until serious complications result. Similarly, the medication cost associated with chronic disease management is often prohibitive. Thus, individuals with chronic diseases may be unable to afford or chose to forego medication to save money. Once again, failure to medicate a chronic condition often results in expensive emergency care. In a group plan, the prevalence of serious complications involving costly medical treatment influences premium rates for the group.

In the health care program of the present invention, an incentive is associated 800 with a particular action or set of actions pertaining to the health care of a participating member. The incentive is offered to encourage the participating member to comply with the requests and instructions of the inside health care provider. Various incentives are available to encourage participation. The success of any particular type of incentive depends on the expectations of the participating members. In the most general form, the incentive is a monetary award, a gift (tickets, gift certificates, etc.), or a benefit (additional time off, etc.), with or without stipulations. In some cases, the actions and incentives are standard and are available to any participating member who qualifies. In other cases, the actions and incentives are standard but are only available to particular a member subset. Finally, custom actions and incentives can be established for a member subset or a participating member, within the bounds of the health care program established by the group.

Before the incentive is distributed to the participating member, the inside health care program coordinator confirms 802 that the participating member has met the requirements to receive the incentive, i.e., the reward condition. This is typically accomplished by having the participating member submit proof of compliance directly to the health care program coordinator or to the inside health care provider, which forwards such proof on to the health care coordinator. As previously mentioned, one reward condition is the maintenance and presentation of a log kept by a participating member to establish compliance with program requirements. A log is generally used where a participating member is required to keep a contemporaneous running record of recurring results, measurements, diet, activity, and other similar things. In one embodiment using a log, the inside health care provider verifies the completeness of the log and advise the health care program coordinator that the log is complete. Alternatively, a copy of the log or other document, such as test results, will serve as proof of compliance.

When the health care program coordinator receives confirmation that the reward condition has been met, the health care program coordinator authorizes 804 the incentive provider to distribute the reward to the qualifying member. The incentive provider subsequently delivers 806 the reward to the qualifying member. Finally, the funding of the incentives program is monitored by the health care program provider to ensure that the incentives are available for distribution to qualifying members when required. When it is determined that the incentive program is insufficiently funded, the health care program provider notifies the group to arrange for additional funding or to modify the incentive program based on modifications to the funding arrangement desired by the group.

Generally, rewards serve to reduce or eliminate impediments to improving the health of the participating members. It has been noted that monetary constraints and lack of urgency are two primary impediments. Monetary constraints discourage individuals from seeking health care that is often considered unnecessary, which generally disproportionately affects preventative care. However, the lack of preventative care ultimately increases the likelihood of the need for catastrophic care. Monetary constraints limit the ability of individuals having a condition involving recurring treatment or maintenance expenses to obtain the necessary medicines and/or medical supplies. This also increases the likelihood of the need for catastrophic care. Further, individuals with and without monetary constraints are susceptible to ignoring or avoiding health care when not motivated by a sense of urgency. Once again, this disproportionately affects preventative care. Annual checkups are routinely ignored when the individual feels fine and minor symptoms can be overlooked when seeking medical assistance for a matter perceived as trivial would detract from work or other activities.

There are a number of types of rewards which are useful in the health care program of the present invention to address the impediments described above. A first type of reward is a gift provided to a participating member achieving a specific health goal, such a reduction in weight, blood pressure, or cholesterol, or completing a specified activity, such as attending a health education seminar, receiving preventative health care testing, or participating in a event such as group health walk. The gifts provided are typically of a unique character and sufficiently interesting to motivate a participating member to strive for the reward condition regardless of whether an economic impediment exists. When coupled with personal motivation engendered by a participating member seeing improvement in their personal health, a gift incentive provides outside motivation to maintain personal motivation.

Another type of incentive involves a program generally referred to as a health reimbursement account where a group reimburses a group member for at least a portion of actual health expenses not otherwise covered by ancillary programs such as health insurance or co-payments for which the group member would normally be responsible. In lieu of a conventional health reimbursement plan, one embodiment of incentive program provides a stipend or reimbursement for health care expenses arising out of or relating to the health care program. Such health care expenses include expenses associated with outside health care providers when referred by the health care program provider, expenses for health care services falling within the objectives of the health care program obtained by the participating member, for example, preventative health care services and follow-up/monitoring/maintenance health care appointments, and premiums associated with health insurance. In certain embodiments, stipends are provided for health care services comporting with the objectives of the health care program event where the participating member experience no out-of-pocket expense. The stipends are generally subject to restrictions such as being limited to use for payment of health care service expenses; however, such restrictions need not be required.

An additional type of incentive involves financial assistance for participating members having recurring prescription expenses. Typically, this involves participating members involved in chronic disease management such as diabetes, high cholesterol, hypertension, and other on-going conditions. Management of such conditions also typically involves regular monitoring of one or more indicators associated with the condition by the patient outside of the control of the health care provider, such as daily blood glucose testing. A patient who monitors the indicators and is aware of the consequences is more likely to notice changes in the condition before the complications develop. However, the expenses involved with the monitoring of the indicators and the prescriptions for managing the condition represent a significant expense, especially for group members earning close to minimum wage. To encourage both regular monitoring and continued usage of necessary medication, a monetary payment covering at least a portion of the expenses for the supplies and/or the medication is provided to the participating member establishing regular monitoring of the condition and purchase of medications. Thus, one reward condition for such incentive is the keeping and presentation of a log of monitoring results (e.g., daily blood pressure, glucose levels, weight, etc.) and presentation of receipts showing the required medications have been obtained by the participating member. Reward distribution is handled in various ways including reimbursement through a health reimbursement account or a direct payment to the participating member.

It should be appreciated that the incentive program may be structured to provide varying rewards based on additional criteria such as income level, job description, or family size. Because of the disproportionate impact of health care expenses on the budget of participating members with lower incomes or larger families, the rewards, reimbursements, stipends, or assistance may be structured to provide greater incentive to those least likely to actively participate in health care program.

The incentive program described herein has been found by the present to improve the effectiveness of the health care program because it is coordinated by the health care program provider and designed to target one or more group health objectives by encouraging involvement of the participating members. By designing the incentive program to encourage the participating members to strive for common goals and reduce or remove impediments to proper health care, in conjunction with the coordinated care of the health care program, the health care program of the present invention is less susceptible to the individual predilections and haphazard regard for personal health common to individuals and contributing to increased health care costs.

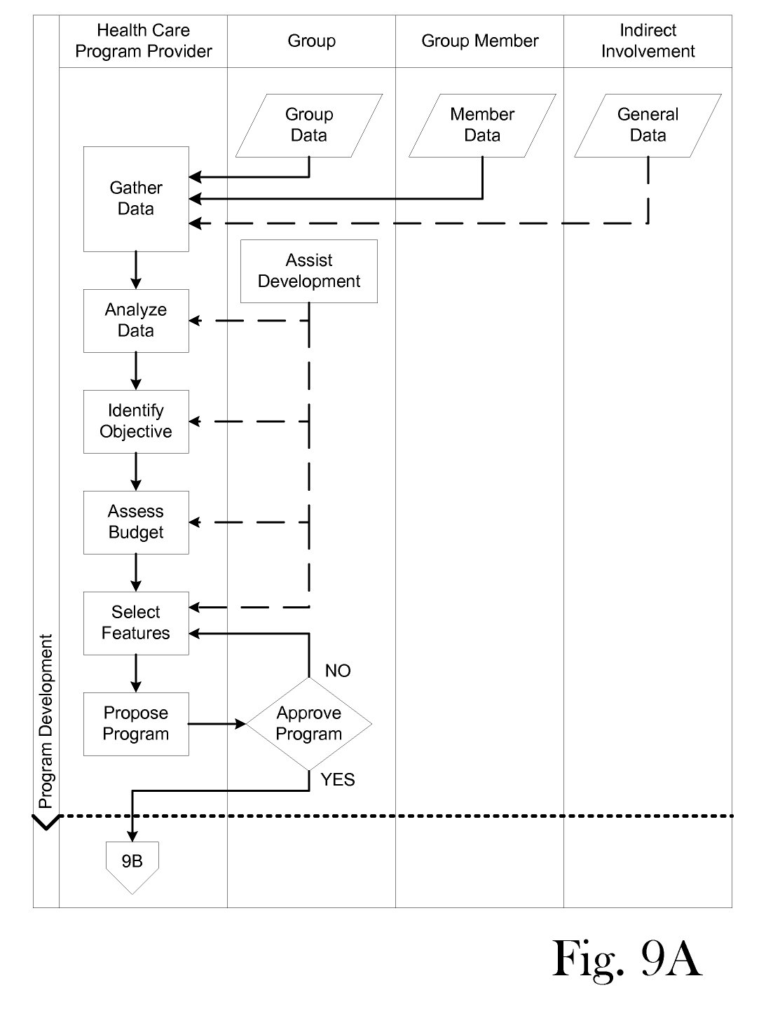

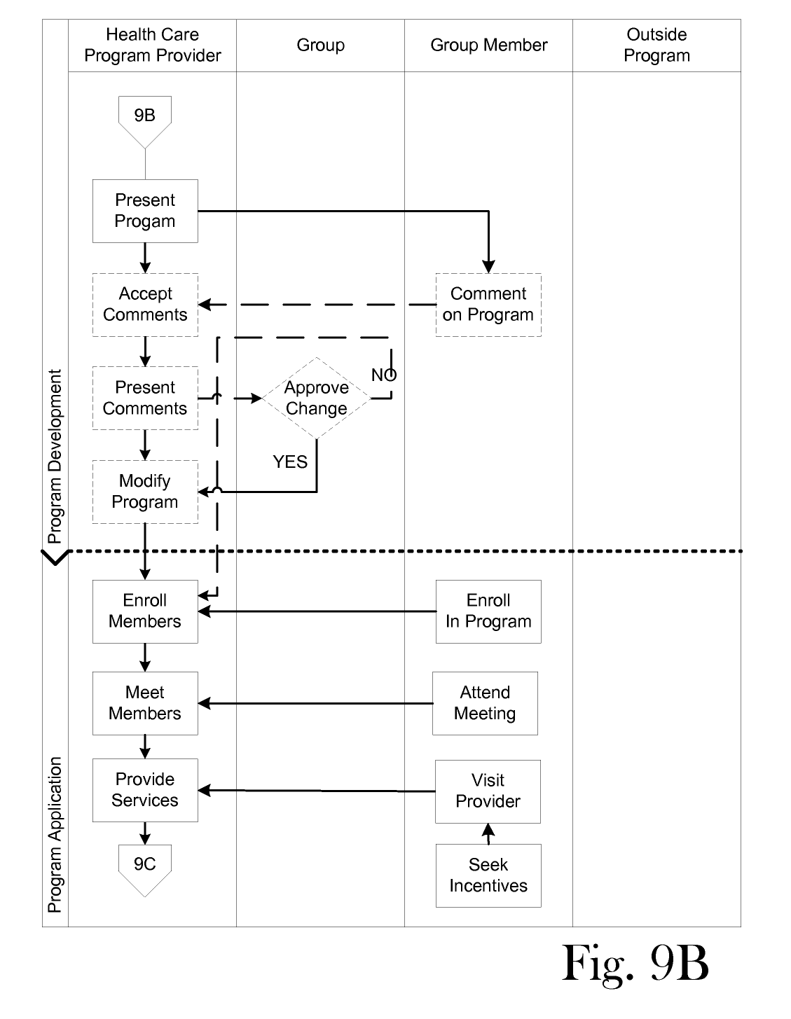

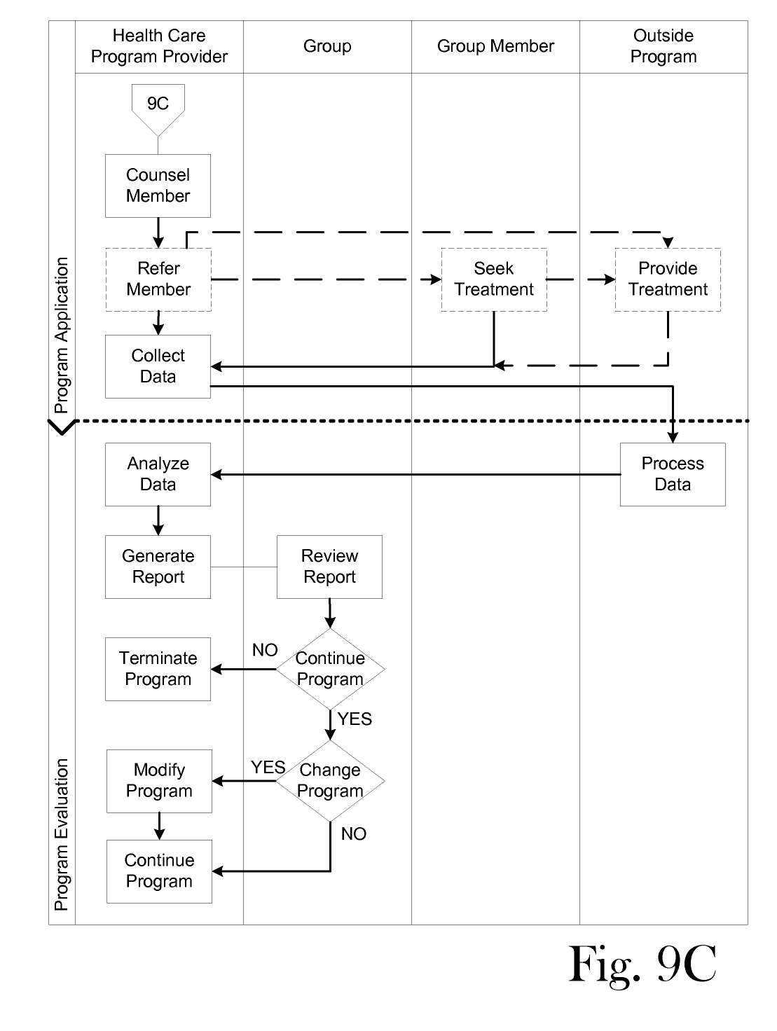

FIGS. 9A-9C illustrate a cross-functional diagram of one application of the method for providing centrally-managed health care services for a group. Initially, the health care program provider collects data from various sources including the group, the group members, and outside sources such as industry data and general health care statistics. The health care program provider subsequently analyzes the data to determine the health care issues facing the group and the remedies available in view of the allotted resources.

To this extent, the analysis optionally includes a study of medical information pertaining to the group members in order to determine at least one health concern present in a significant percentage of the member pool, which may or may not directly correspond to the actual group members. The member pool is a collection of group members and related individuals to which health care is to be administered through the established health care program. In one application of the method, a member pool is identified during the program development analysis. In one embodiment, the member pool includes only the members of the group. In another embodiment, the member pool includes both current and former group members in good standing, e.g., current employees and retirees. In still another embodiment, the member pool includes group members and their immediate family members. One skilled in the art will recognize other suitable criterion for selection of the patient set, and such criterion may be used without departing from the spirit and scope of the present invention, including indications from group members declining or indicating an intent to decline being included in the health care program.

Subsequently, the health care program provider determines an objective in the provision of health care services to the group members. One objective consistent with a wide range of health concerns is to specifically reduce the severity of the at least one health concern. For example, if hypertension is identified among a significant percentage of the group members, a suitable objective is to reduce the average blood pressure of the group members. Other objectives beyond reducing the severity of the at least one health concern may be selected. By way of example, where osteoporosis is identified among a significant percentage of the patient set, an objective to educate the group members with regard to the nutrition so as to better prepare group members to minimize the onset of dietary-related conditions. One skilled in the art will appreciate that numerous variations in the established goal are possible, depending upon the specific needs of the patient set, as well as the needs of the management entity.

The health care provider further evaluates or assesses the budget in relation to other available information including factors such as the identified health concern and the desired objective as a tool to establish what health services can be funded in the health care program. In one embodiment, the development unit performs a financial needs assessment to determine any financial constraints associated with the group funding the health care program. One skilled in the art will recognize various factors pertinent in determining such financial constraints, including but not limited to the ability and willingness of the managing entity to provide funding, and the particular scale and scope of the health care program desired by the managing entity.

Upon establishment of the desired objective and assessment of the budget, the development unit performs any further analysis of the data pertaining to various existing heath conditions of the group and/or each individual group member to assess the particular services, characteristics, or features of health services that are to be administered in order to achieve the desired objective. The parameters used in assessing the health care feature set to be administered are dependent upon several factors, including but not limited to the needs and objectives of the group, the resources of the group, the desired time for achievement of the objective, the available staffing, and other constraints particular to the managing entity. As an example, the features of the administered health care are assessed based upon the parameter of the group's desire not to interrupt the normal business functions of the group members during the hours of operation of the group. Those skilled in the art will recognize other parameters suitable for consideration by the development unit in assessing the health care feature set including the standards applicable to the group as a whole or to a subset of group members that set forth the health assessments and/or care that are deemed appropriate and necessary. Feature selection also involves setting parameters of treatment to be utilized in the health care program. In one embodiment, the development unit determines the frequency of treatment and testing to be provided in order to achieve the objective. In another embodiment, the development unit determines the method in which the health care is to be applied. In still another embodiment, the development unit selects a specific demographic to receive certain health services or health services having altered characteristics from the health care designated to be received by the remainder of the group members.

In selecting the actual features of the health care program including health services, the data concerning existing heath conditions of individual group members or common in groups considered demographically equivalent is used. In one embodiment, preliminary health assessments of the group members are performed to provide reliable medical data on which to base the health care program. Both the preliminary assessments and the health care program optionally include ancillary testing which may be outside the scope of routine health care.

Upon completion of analysis of the data, the development unit compiles the various health services feature set, ancillary testing, and the parameters of treatment determined through the analysis into a health care program. The development unit then presents the health care program to the managing entity for approval or disapproval. Upon disapproval of the health care program by the group, the development unit reviews the concerns with the proposed health care program with the group to identify those characteristics of the health care program that resulted in the disapproval of the health care program. The development unit modifies the health care program and represents the changed health care program to the group for further review and approval. This process is repeated as necessary to develop a health care program acceptable to the group.

During the development phase, the group may opt to participate with the development unit in any or all of the tasks and functions described herein to guide and direct the development of the health care program. Optionally, representatives of the group members may be involved, to the extent permitted by the group, in the development of the health care program. One skilled in the art will appreciate that receiving additional input and opinions from the group and group members on the front end may eliminate the need to revise a proposed health care program but may also result in divergent goals and concerns that hamper or delay the development of the health care program.

Upon approval of the health care program by the group, the health care program is presented to the group. In one embodiment, the development unit accepts feedback from group members regarding proposed modifications in the implementation of the health care program. Such constraints include, but are not limited to, scheduling for provision of health care, additional care requested by the individual patient, willingness and unwillingness of an individual patient to receive certain care, and the like. The development unit then analyzes the feedback to determine which, if any, desired modifications could be implemented into the health care program without deviating from the objective of the health care program or requiring substantial rework of the health care program. If a proposed modification is determined to be possible to implement into the health care program while maintaining anticipated achievement of the objective through application of the health care program to the patient set, the group can elect to implement such desired constraint. If a proposed modification is determined to be impossible to implement while maintaining anticipated achievement of the objective, such desired constraint is not implemented. Following any implementation of proposed modification provided by the various individual patients, the health care program is once again presented to the group for approval and this process can be repeated as necessary to finalize the health care program features.

Next, the health care program is implemented and health care and enrollment is allowed. In one embodiment, enrollment is a formal process and in another embodiment enrollment of all group members is presumed. Health services are provided to the group members, within the parameters of treatment and the constraints added through the presentation processes. An initial meeting is held between the inside health care provider and the group members, whereupon the inside health care provider explains the manner in which the health care is to be provided. In one embodiment, separate initial meetings with individual group members are held. In another embodiment, initial meetings with certain target groups (member subsets) within the group are held. As previously discussed, the initial meeting provides an opportunity to schedule and coordinate future health services.

The health care program provider provides health services including periodic health assessments to the group members. Group member participation is optionally motivated by the offering of incentives. When seeking incentives available through the health care program, the group member is more likely to participate. Results of the health care assessment are provided to the group member during post-assessment counseling addressing any prevailing health issues or concerns.

Those skilled in the art will recognize that several embodiments of the method result in the collection of data by the inside health care provider during the implementation of the health care program which pertains to the health of each participating group member. In one embodiment, the data collected by the inside health care provider is reviewed to determine for each individual patient whether any health issues exist which should be referred to an outside health care provider. Upon discovery of such a health issue, the data analyst informs the inside health care provider of the health issue, whereupon the inside health care provider then instructs the corresponding individual patient to seek the care of a outside health care provider. In more discreet embodiments, the inside health care provider communicates directly with an outside health care provider to inform the outside health care provider of the health issue.

After sufficient time has elapsed for meaningful evaluation of the health care program, the health care program provider performs a post-care assessment of the data in order to determine whether the desired objective has been reached. In the illustrated embodiment, the actual data processing is illustrated as provided by an outside vendor. The processed data is analyzed by the health care program provider and a report is generated focusing on the heath conditions present within the group. The health care program provider communicates with the group to inform the group whether the desired objective has been reached. In the illustrated embodiment, the group elects to continue, modify, or terminate the health care program based on the results. In another embodiment, the method terminates based on time or funding regardless of the success or failure of the health care program. In another embodiment, the method terminates only upon informing the group that the desired objective has, in fact, been reached. Upon informing the group that the desired objective has not been reached, implementation of the health care plan is continued.

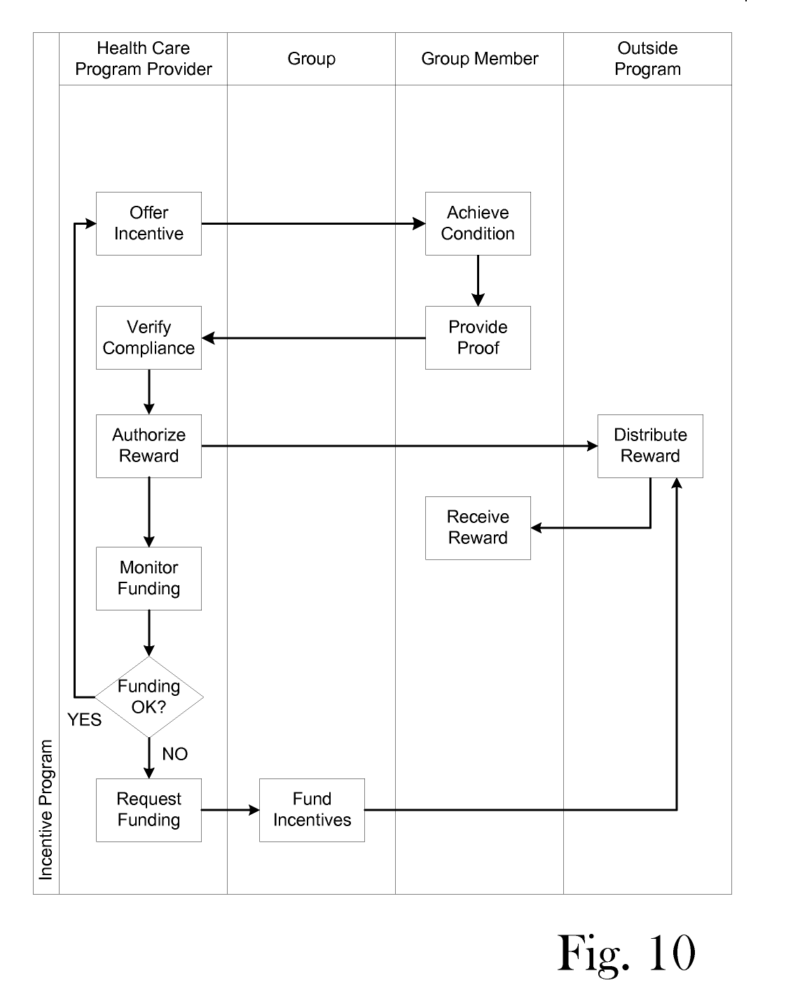

As previously discussed, incentives are offered to group members achieving specified reward conditions illustrated in FIG. 10. In several embodiments, an incentive is provided to encourage group members to comply with the requests and instructions of the inside health care provider. In the case of groups having public interest, the incentive may be provided or funded by a third party interested in the provision of health care to the group. In another embodiment, the incentive provider may have a financial stake in the health of the group, such as insurance company bound to provide insurance coverage to various group members. The insurance company provides a discount in the cost of health care to those group members who comply with the requests and instructions of the inside health care provider.

From the foregoing description, a group health care program using central management has been provided. The group health care program involves the development of health care program designed to address the concerns and objectives of a group and its members. Using health assessments, early diagnosis, preventative or maintenance treatment, patient cooperation, education, and/or incentives, the health care program meets at least the basic goal of providing health services customized for a group. Further, the coordination of the health care program is generally effective in achieving larger goals of reducing health care costs and improving overall health by encouraging the active participation of group members and removing impediments, including financial limitations, the health care program described herein achieves the underlying goals within the bounds of the abilities of the group and the participating members.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

1. A method for providing health care to a group through a health care program provider, the group having a group representative, a plurality of group members, and a group health objective, said method comprising the steps of:
collecting group information from the group representative, said group information comprising at least a budget and the group health objective;
developing a health care program comprising health services and an incentive program for participating members based upon said group information, said participating members comprising a set of said plurality of members participating in said health care program, said health services comprising a periodic assessment adapted to be performed on said participating members, said incentive program comprising a reward condition and a reward associated with said reward condition, said health care program promoting the group health objective using said health services and said incentive program structured to have a cost not exceeding said budget;
providing said health services to participating members;
collecting participating member information during said step of providing at least one of said health services, said participating member information comprising data associated with at least one medical condition occurring in said participating members;
obtaining historical information about said participating members by repeating said steps of providing said health services to participating members and collecting participating member information, said historical information comprising successive participating member information obtained from said participating members;
offering said incentive program to said participating members, said participating members being eligible to receive said reward when said reward condition is met;
distributing said reward to a qualifying member meeting said reward condition; and
analyzing said data from said historical information to identify trends relating to said at least one medical condition within said participating members;
whereby health care directed to the group objective is provided to the group.

2. The method of claim 1 further comprising the step of collecting baseline information from an individual, said individual belonging to said participating members, said baseline information comprising test results representing the health of said individual upon entry into said health care program.

3. The method of claim 1 further comprising the step of collecting preliminary information from an individual, said individual belonging to said participating members, said preliminary information comprising demographic data about said individual and a medical history for said individual.

4. The method of claim 1 further comprising the step of collecting group member information from an individual, said individual belonging to said plurality of group members.

5. The method of claim 4 wherein said step of developing a health care program further comprises the step of considering said group member information in addition to said group information when developing said health care program.

6. The method of claim 1 wherein said group health objective relates to a specific medical condition, said step of providing health services further comprising the step of testing for said specific medical condition.

7. The method of claim 1 wherein said step of providing health services further comprises the steps of:
performing health tests on an individual belonging to said participating members;
obtaining results from said health tests;
providing said individual with a copy of said results of said health tests performed on said individual;
counseling said individual about said results; and
referring said individual to an outside health care provider when warranted by said test results.

8. The method of claim 7 wherein said step of referring said individual further comprises the step of making an appointment for said individual with the outside health care provider and further comprising the steps of:
collecting records pertaining to the appointment with the outside health care provider; and
integrating said records into said participating member information.

9. The method of claim 1 wherein said step of distributing said reward further comprises the steps of:
verifying that an individual has met said reward condition, said individual belonging to said participating members;
identifying said individual meeting said reward condition as said qualifying member; and
authorizing distribution of said reward to said qualifying member.

10. The method of claim 1 wherein said step of developing a health care program further comprises the step of receiving approval of said health care program from the group representative.

11. The method of claim 1 further comprising the steps of
relating a plurality of said participating members using a common feature selected from the group consisting of a medical condition, a group goal, and an individual goal to define a member subset; and
establishing a subset health services applicable to said member subset based on said common feature, said subset health services available only to said participating members belonging to said member subset.

12. The method of claim 1 further comprising the steps of
relating a plurality of said participating members using a common feature selected from the group consisting of a medical condition, a group goal, and an individual goal to define a member subset; and
establishing a subset reward condition for said member subset based on said common feature, said subset reward condition available only to said participating members belonging to said member subset.

13. The method of claim 1 wherein health care expenses are an economic impediment, said method further comprising a step of establishing a reimbursement account for each of said participating members, said reimbursement account holding funds usable to pay for health care expenses, said reward being a monetary disbursement to said reimbursement account associated with an individual, said individual belonging to said participating members, said reward condition being a preventative care activity undertaken by said individual, whereby the economic impediment is reduced.

14. The method of claim 12 wherein medication costs are an economic impediment, said common feature is chronic disease having recurring medication costs, and said subset reward condition is monitoring an indicator related to the chronic disease, further comprising the step of establishing a subset reward providing monetary assistance with medication costs associated with management of the chronic disease to each of said participating members meeting said subset reward condition, whereby the economic impediment is reduced.

15. The method of claim 1 wherein said health care program provider comprises a development unit, a provider unit, an incentive unit, an analysis unit, and a coordination unit; said development unit performing said steps of collecting group information, collecting member information, and developing a health care program; said provider unit performing said steps of providing said health services and collecting participating member information, said incentive unit performing said steps of offering said incentive program and distributing said reward, said analysis unit performing said step of analyzing said data, said coordination unit in communication with said development unit, said provider unit, said incentive unit, and said analysis unit; said method further comprising the step of coordinating said steps of collecting group information, collecting member information, developing a health care program, providing said health services, collecting participating member information, offering said incentive program, distributing said reward, and analyzing said data; said coordination unit being in communication with said development unit, said provider unit, said incentive unit, and said analysis unit.
